(19) United States
(12) Patent Application Publication
(10) Pub. No.: US 2024/0393200 A1
(43) Pub. Date: Nov. 28, 2024

(54) MICROMECHANICAL SENSOR SYSTEM WITH A MICROMECHANICAL STRUCTURE, AND METHOD FOR OPERATING A MICROMECHANICAL SENSOR SYSTEM WITH A MICROMECHANICAL STRUCTURE

(71) Applicant: Robert Bosch GmbH, Stuttgart (DE)

(72) Inventors: Amin Jemili, Kusterdingen (DE); Christoph Puttmann, Kusterdingen (DE); Julian Schwarz, Tuebingen (DE)

(21) Appl. No.: 18/660,275

(22) Filed: May 10, 2024

(30) Foreign Application Priority Data
May 22, 2023 (DE) 10 2023 204 722.5

(51) Int. Cl. G01L 19/00; G01C 19/5776; G01P 3/44

(52) U.S. Cl. CPC G01L 19/00; G01C 19/5776; G01P 3/44

(57) ABSTRACT

A micromechanical sensor system with a micromechanical structure and with a control and sensing device. The micromechanical sensor system is configured for repeatedly generating and outputting sensor measured values at a specified output data rate, and at an output of the micromechanical sensor system. During a first part of an output time interval, the control and sensing device realizes an energy-saving operating mode, and, for generating the sensor measured values, the micromechanical structure is controlled and/or its position or configuration is sensed by the control and sensing device during the output time interval. Temporally after the first part of the output time interval and as part of the measurement time interval, during a preparation or downtime interval, the generation of the sensor measured values is prepared. The duration of the preparation or downtime interval and/or the first part of the output time interval is changeable or adaptable.

### CROSS REFERENCE

The present application claims the benefit under 35 U.S.C. § 119 of German Patent Application No. DE 10 2023 204 722.5 filed on May 22, 2023, which is expressly incorporated herein by reference in its entirety.

### FIELD

The present invention relates to a micromechanical sensor system with a micromechanical structure and with a control and sensing device.

### BACKGROUND INFORMATION

Micromechanical sensor systems for measuring accelerations, rotation rates, air pressure, etc. are an integral part of a variety of applications for electronic devices. Especially in relation to specific applications or uses and their requirements for the power demand or energy consumption and/or the signal stability and signal quality of the micromechanical sensor system, there are often conflicts of objectives since most often only either the power demand, or energy consumption, or the signal stability and signal quality can be optimized. A widely used possibility for savings or achieving the lowest possible power demand or energy consumption for a variety of applications (i.e., a consumption-optimized operating mode) is the operation of the micromechanical sensor system in a so-called low power mode, within which the micromechanical sensor system is started in a short time (at the beginning of the measurement interval), a measurement (by means of parameters defined during production) is carried out comparatively quickly, or sensor measured values are generated comparatively quickly, and the micromechanical sensor system or the control and sensing device is subsequently (again) put into energy-saving mode (duty cycle).

In addition to the aforementioned method of a (consumption-optimized) operation of the micromechanical sensor system (duty cycle), it is furthermore conventional to use suitable circuits, for example consisting of fast analog-to-digital converters (ADC), which can also be used to generate sensor measured values comparatively quickly.

However, the above-mentioned methods for optimizing power demand or energy consumption reach their limits since, due to transient phenomena of the mechanical structure within the measurement time intervals (which transient phenomena are, for example, produced by the application of a reading voltage; so-called downtimes in which no sensor measured values can be generated or in which the sensor measured values are extremely erroneous, for example due to such transient phenomena of the mechanical structure), the measurement time intervals are not arbitrarily reducible. When selecting a shorter downtime (with a view to the shortest possible measurement time interval for energy-saving reasons), the generation of the sensor measured values will tend to be more error-prone, which negatively affects the signal stability and the signal quality and leads to the aforementioned conflicts of objectives since accepting a longer downtime also requires more power-intensive operation of the micromechanical sensor system.

The related art provides for already defining such downtime intervals, in which no sensor measured values or only error-prone sensor measured values are (can be) generated, during the production of the micromechanical sensor system; they can thus only be selected for the respective specific application or use (and its requirements) and are thus already defined during the production of the sensor system. The technical task thus arises to design a micromechanical sensor system such that the operation of the micromechanical sensor system, in particular with regard to the energy consumption, is flexibly adaptable to specific applications or uses and their requirements, in particular also during (ongoing) operation, for example by a user.

### SUMMARY

It is an object of the present invention to provide a micromechanical sensor system with a micromechanical structure and with a control and sensing device which does not have the aforementioned disadvantages.

The micromechanical sensor system according to the present invention with a micromechanical structure and with a control and sensing device according to present invention may have the advantage over the related art that, on the one hand, the generation of the sensor measured values is prepared (temporally after the first part of the output time interval and as part of the measurement time interval) during the preparation or downtime interval and, on the other hand, the duration of the preparation or downtime interval and/or the first part of the output time interval is changeable or adaptable even after the production of the micromechanical sensor system. The adaptability of the duration of the preparation or downtime interval and/or of the first part of the output time interval even after the production of the sensor system makes it extremely advantageously possible to design the operation of the micromechanical sensor system or the initial operation of the micromechanical sensor system, in particular for specific applications or uses. This is advantageously possible in that, on the one hand, for an application or use that has a high power demand or energy consumption for providing a signal stability and signal quality appropriate for the application or use, an advantageous duration of the preparation or downtime interval and/or of the first part of the output time interval can be adapted or selected and, if necessary, in the further course or in the further operation, in the case that the specific application or usage requirements change, the duration of the preparation or downtime interval and/or of the first part of the output time interval can (again) be advantageously adapted. The latter case may occur, for example, as a result of a change in the requirements for the signal stability and signal quality: Their prioritization can be reduced in the case of a (now) increased requirement for the power demand or energy consumption (i.e., a reduced power demand or energy consumption is required).

By the possibility of such a further configurability of the sensor system according to the present invention, it is also possible, for example, to completely bridge the preparation or downtime interval (i.e., to reduce it to 0) or to set it to a minimum value; furthermore, the preparation or downtime interval can also be selected according to (or due to) a desired precision criterion (of the sensor measured values).

Advantageous configurations and developments of the present invention can be taken from the disclosure herein.

According to an advantageous configuration of the present invention, it is provided that the micromechanical sensor system is operable in at least one first operating mode and in at least one second operating mode, wherein the at least one first operating mode represents a consumption-optimizing operating mode and the at least one second operating mode represents a power-optimizing operating mode, wherein, in the at least one first operating mode, the duration of the first part of the output time interval is greater and/or the duration of the preparation or downtime interval is less than in the at least one second operating mode, wherein switching from a first operating mode to a second operating mode or vice versa is made possible even after the production of the micromechanical sensor system. Providing the at least one first operating mode and the at least one second operating mode, and in particular the possibility of switching between these two operating modes, in particular after the production, has the extremely advantageous result that, during the operation of the micromechanical sensor system specifically for a specific application or use, the at least one first operating mode can be provided or selected in the case of an application or use that requires a consumption-optimized operating mode, and also, with respect to an application or usage change toward an application or use that requires a power-optimized operating mode, switching from the consumption-optimized operating mode to the power-optimized operating mode is possible. This likewise applies to switching the operating modes in the opposite direction. Furthermore, the consumption-optimized operating mode represents an operating mode with a priority toward a low power demand or energy consumption, and the power-optimized operating mode represent an operating mode with a priority toward high signal stability and signal quality. The latter accordingly requires a high or higher power demand or energy consumption.

According to an advantageous configuration of the present invention, it is provided that the micromechanical sensor system makes switching from a first operating mode to a second operating mode or vice versa possible in operation, in particular by changing the duration of the preparation or downtime interval and/or the first part of the output time interval by means of a parameter specification. Providing or entering an (individual) parameter specification can thus effectively ensure switching from the first operating mode (here, by way of example, understood as a consumption-optimized operating mode, for an application or use that has a requirement for the lowest possible power demand or energy consumption) to the second operating mode (here understood as a power-optimized operating mode, for an application or use that has a requirement for the highest possible signal quality and signal stability) in the operation of the micromechanical sensor system. Thus, the individually adjustable parameter specification provides a possibility of switching the operating mode of the micromechanical sensor system individually to the specific application or use with the associated requirements for the power demand or energy consumption and/or for the signal stability and signal quality.

According to an advantageous configuration of the present invention, it is provided that the micromechanical sensor system is configured in such a way that, repeatedly during the duration of an output time interval as well as in a manner initiated or controlled by means of a timer at the start of a further measurement cycle:
a system start takes place at the beginning of the measurement time interval,
waiting takes place for a transient waiting time corresponding to the preparation or downtime interval, with the possibility of changing or adjusting the waiting time by means of a parameter specification,
a measurement for generating sensor measured values takes place, and
the control and sensing device is largely shut down at the beginning of the first part of the output time interval.

Changing or adjusting the parameter specification (i.e., the changeability or adaptability thereof) during the measurement cycle (i.e., during operation) extremely advantageously results in the possibility of in particular adapting the transient waiting time to a specific application or use and thus likewise of ensuring or achieving a low power demand or energy consumption in the consumption-optimized first operating mode through an adapted transient waiting time (adapted by means of the parameter specification). This likewise applies to the power-optimized second operating mode, which ensures or accomplishes high signal stability and signal quality through the adapted transient waiting time (adapted by means of the parameter specification). In particular, through a suitable parameter specification, switching from the consumption-optimized first operating mode to the power-optimized operating mode (both adapted to a respective specific application or use with its requirements) can extremely advantageously be realized.

According to an advantageous configuration of the present invention, it is provided that the first part of the output time interval takes up a time proportion of at least 30%, preferably 50%, further preferably 60%, further preferably 70%, further preferably 808, of the output time interval. As a result, it is advantageously possible to ensure an effective and efficient operation.

According to an advantageous configuration of the present invention, it is provided that the micromechanical sensor system comprises at least a rotation rate sensor, a linear acceleration sensor, a pressure sensor. It is thus advantageously possible to ensure an effective and efficient operation.

A further subject of the present invention is a method for operating a micromechanical sensor system with a micromechanical structure and with a control and sensing device according to the present invention.

The method according to the present invention for operating a micromechanical sensor system with a micromechanical structure and with a control and sensing device proves to be advantageous over the related art in that, during operation, on the one hand, the generation of the sensor measured values is prepared (temporally after the first part of the output time interval and as part of the measurement time interval) during the preparation or downtime interval and, on the other hand, the duration of the preparation or downtime interval and/or the first part of the output time interval is changeable or adaptable even after the production (i.e., even during operation). In particular through the changeability or adaptability of the duration of the preparation or downtime interval and/or of the first part of the output time interval, an extremely advantageous adaptation to the specific application or use for the micromechanical sensor system can be ensured in the operation of the micromechanical sensor system. Due to the adaptation of the duration of the preparation or downtime interval and/or of the first part of the output interval during operation, both operation for an application or use that has a requirement for high signal stability and signal quality, and operation for an application or use that has a requirement for a low power demand or energy consumption can be ensured or achieved. In particular, it is even possible to respond to a change in the applications or uses, more precisely to a change in the requirements of the applications or uses, by means of an adaptation of the duration. For example, it is thus possible to first operate the micromechanical sensor system for a specific application or use with the requirement for an operation with a low power demand or energy consumption and, due to a change in the requirements for the operation, to change the duration and thus to respond to an application or use with the requirement for, for example, high signal quality and signal stability.

Advantageously, according to an example embodiment of the present invention, the preparation of the generation of the sensor measured values during the preparation or downtime interval (i.e., temporally after the first part of the output time interval and as part of the measurement time interval) is added. This supports the operation of the micromechanical sensor system in an advantageous manner with respect to the operation for the specific application or use and its requirements for the micromechanical sensor system, in particular the change in the requirements of the specific application or use and the resulting change in the duration of the preparation or downtime interval during operation.

The advantages and configurations described in connection with the example embodiments of the micromechanical sensor system according to the present invention with a micromechanical structure and with a control and sensing device may be applicable to the method for operating a micromechanical sensor system with a micromechanical structure and with a control and sensing device.

Exemplary embodiments of the present invention are shown in the figures and explained in more detail in the following description.

### BRIEF DESCRIPTION OF THE DRAWINGS

FIG. 1 schematically shows two diagrams, which show a time curve of a method for operating a micromechanical sensor system with a micromechanical structure and with a control and sensing device according to an example embodiment of the present invention.

FIG. 2 schematically shows a circuit diagram of the micromechanical sensor system with a micromechanical structure and with a control and sensing device according to one example embodiment of the present invention.

FIG. 3 shows a flowchart of an exemplary embodiment of a method for operating a micromechanical sensor system with a micromechanical structure and with a control and sensing device according to the present invention.

### DETAILED DESCRIPTION OF EXAMPLE EMBODIMENTS

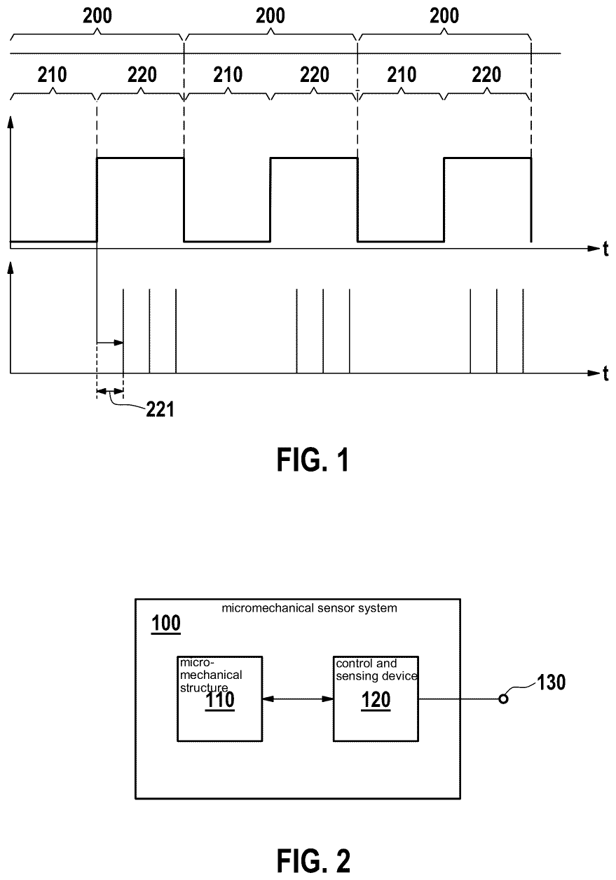

FIG. 1 schematically shows a (periodic) time curve of a method for operating a micromechanical sensor system according to the present invention. An upper subarea shows three period lengths of an output time interval 200 corresponding to the output data rate of the micromechanical sensor system, each with a same division for a first part 210 of the output time interval 200 and a measurement time interval 220. They are plotted in a time IDD diagram. By way of example, the first part 210 of the output time interval 200 and the measurement time interval 220 take up about the same time window or the same duration within the output time interval 200; however, this division is not to be considered to be to scale; in particular, the aim is generally to increase the first part 210 of the output time interval in order to achieve the lowest possible energy consumption of the sensor system, preferably at the expense of the measurement time interval 220.

A lower subarea of FIG. 1 shows a diagram, which likewise represents the time curve and, for example, shows the times of measurements carried out (i.e., within the respective time range shown as the measurement time interval 220 in the upper subarea) or also sampling points or measurement times (vertical dashes) for generating the sensor measured values. The time duration between the beginning of the measurement time interval 220 and the respective first measurement point (left vertical dash of a group of vertical dashes) exemplifies the duration of the preparation or downtime interval 221 (this is drawn for the first measurement time interval 220 in FIG. 1, but not for the further measurement time intervals 220).

During operation (i.e., after the production) of the micromechanical sensor system, the micromechanical sensor system can be adapted to specific applications or uses or their requirements. The duration of the preparation or downtime interval 221 and/or of the first part 210 of the output time interval 200 can also be changed or adapted after the production. It is thus advantageously possible to respond to the requirements of a particular application or use by means of a suitable adaptation, and in particular to changes in the requirements, during the operation of the micromechanical sensor system.

FIG. 2 schematically shows the micromechanical sensor system 100 with a micromechanical structure 110 and with a control and sensing device 120 according to one embodiment of the present invention. As a further element of the micromechanical sensor system 100, an output 130 is shown, which provides sensor measured values for connected components or applications. The micromechanical sensor system is operated in such a way that (temporally after the first part 210 of the output time interval 200 and as part of the measurement time interval 220) during the preparation or downtime interval 221, the generation of the sensor measured values is prepared and the duration of the preparation or downtime interval 221 and/or the first part 210 of the output time interval 200 can be changed or adapted even after the production of the micromechanical sensor system 100 (i.e., also during operation; for example, by means of switching from the at least one first operating mode to the at least one second operating mode by means of a parameter specification).

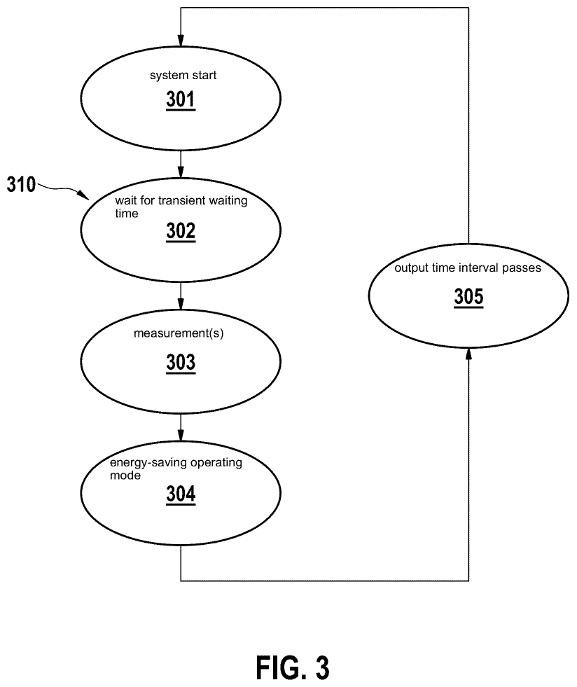

FIG. 3 schematically shows an exemplary flowchart of an exemplary configuration of a method for operating the micromechanical sensor system 100 with the micromechanical structure 110 and with the control and sensing device 120 according to the present invention. During the output time interval 200, the illustrated flow repeats: Shown is the beginning of the flow with a system start 301 at the beginning of the measurement time interval 220. Next, waiting takes place for a transient waiting time 302 corresponding to the preparation or downtime interval 221, wherein it is possible to change or adjust the transient waiting time 302 by means of the parameter specification 310. In particular, in the operation of the micromechanical sensor system, the parameter specification 310 can initiate switching from the at least one first operating mode to the at least one second operating mode. Furthermore, a measurement or a plurality of measurements 303 for generating sensor measured values takes place, and the control and sensing device 120 is subsequently largely shut down 304 (energy-saving operating mode); this is the beginning of the first part 210 of the output time interval 200. After this first part 210 of the output time interval has passed (step 305), a system start 301 is carried out again.

In particular, it is thus advantageously possible according to the present invention to respond to requirements for specific applications or uses in the operation of the micromechanical sensor system 100 since the duration of the preparation or downtime interval 221 can be adapted by means of the changeability or adjustability of the transient waiting time 302 by means of the individual parameter specification 310 and can even be adapted during the operation of the micromechanical sensor system 100.

Thus, it is advantageously possible by means of the micromechanical sensor system 100 according to the present invention to provide a user with an option to make a respective optimum of signal stability and current demand possible in a specific application.

What is claimed is:

1. A micromechanical sensor system, comprising:
a micromechanical structure; and
a control and sensing device;
wherein the micromechanical sensor system is configured for repeatedly generating and outputting sensor measured values:
at a specified output data rate, and
at an output of the micromechanical sensor system,
in such a way that, during a first part of an output time interval corresponding to the output data rate of the micromechanical sensor system, the control and sensing device realizes an energy-saving operating mode, and, for generating the sensor measured values, the micromechanical structure is controlled and/or its position or configuration is sensed by the control and sensing device during the output time interval;
wherein, temporally after the first part of the output time interval and as part of a measurement time interval, during a preparation or downtime interval, the generation of the sensor measured values is prepared, wherein a duration of the preparation or downtime interval and/or the first part of the output time interval is changeable or adaptable after production of the micromechanical sensor system.

2. The micromechanical sensor system according to claim 1, wherein the micromechanical sensor system is operable in at least one first operating mode and in at least one second operating mode, wherein the at least one first operating mode represents a consumption-optimizing operating mode and the at least one second operating mode represents a power-optimizing operating mode, wherein, in the at least one first operating mode, a duration of the first part of the output time interval is greater and/or a duration of the preparation or downtime interval is less than in the at least one second operating mode, and wherein switching from a first operating mode to a second operating mode or from the second operating mode to the first operating mode is made possible even after the production of the micromechanical sensor system.

3. The micromechanical sensor system according to claim 1, wherein the micromechanical sensor system makes switching from a first operating mode to a second operating mode or from the second operating mode to the first operating mode is possible in operation, by changing the duration of the preparation or downtime interval and/or the first part of the output time interval, by a parameter specification.

4. The micromechanical sensor system according to claim 1, wherein the micromechanical sensor system is configured in such a way that, repeatedly during the duration of the output time interval and in a manner initiated or controlled using a timer at a start of a further measurement cycle:
a system start occurs at a beginning of the measurement time interval,
waiting takes place for a transient waiting time corresponding to the preparation or downtime interval, with a possibility of changing or adjusting the waiting time using a parameter specification,
a measurement for generating sensor measured values takes place, and
the control and sensing device is largely shut down at a beginning of the first part of the output time interval.

5. The micromechanical sensor system according to claim 1, wherein the first part of the output time interval takes up a time proportion of at least 30% of the output time interval.

6. The micromechanical sensor system according to claim 1, wherein the micromechanical sensor system includes at least one of a rotation rate sensor, a linear acceleration sensor, a pressure sensor.

7. A method for operating a micromechanical sensor system with a micromechanical structure and with a control and sensing device, the micromechanical sensor system being configured for repeatedly generating and outputting sensor measured values at a specified output data rate, and at an output of the micromechanical sensor system, the method comprising the following steps:
during a first part of an output time interval corresponding to the output data rate of the micromechanical sensor system, realizing, by the control and sensing device, an energy-saving operating mode;
for generating the sensor measured values, controlling and/or sending a position or configuration of the micromechanical structure by the control and sensing device during the output time interval;
temporally after the first part of the output time interval and as part of measurement time interval, during a preparation or downtime interval, preparing the generation of the sensor measured values; and
changing or adapting a duration of: (i) the preparation or downtime interval, and/or (ii) the first part of the output time interval after production of the micromechanical sensor system.
